(19) United States
(12) Patent Application Publication
(10) Pub. No.: US 2026/0325996 A1
(43) Pub. Date: Oct. 22, 2026

(54) FILTER CARTRIDGE ASSEMBLY AND WATER PURIFICATION DEVICE

(71) Applicants: FOSHAN MIDEA CHUNGHO WATER PURIFICATION EQUIPMENT CO., LTD., Foshan (CN); MIDEA GROUP CO., LTD., Foshan (CN)

(72) Inventors: Tingjian HUANG, Foshan (CN); Zudong MO, Foshan (CN); Peng GUI, Foshan (CN)

(21) Appl. No.: 18/879,358

(22) PCT Filed: Nov. 14, 2024
(86) PCT No.: PCT/CN2024/132119

§ 371 Date: Dec. 27, 2024

(30) Foreign Application Priority Data
Dec. 28, 2023 (CN) 202323618627.7
Dec. 28, 2023 (CN) 202323619912.0
Dec. 28, 2023 (CN) 202323621492.X

(51) Int. Cl. B01D 29/96; B01D 29/11

(52) U.S. Cl. CPC B01D 29/96; B01D 29/117; B01D 2201/295; B01D 2201/4023; B01D 2201/4046; B01D 2201/4084

(57) ABSTRACT

A filter cartridge assembly includes a filter cartridge base body having a mount cavity and a mount port communicating with the mount cavity, a filter cartridge body inside the mount cavity and including a water path plate and a rotatable connector at two ends of the filter cartridge body, respectively, and an end cover provided at the mount port and rotatably connected to the filter cartridge body through the rotatable connector. A guide-out slot communicating with the mount port is provided at an inner wall of the mount port and extends obliquely along a circumference direction of the mount port. The end cover includes a snap protrusion at an outer peripheral wall of the end cover and corresponds to the guide-out slot. The snap protrusion is slidable along the guide-out slot to bring a part of the filter cartridge body away from the mount cavity along an axial direction.

### CROSS-REFERENCE TO RELATED APPLICATIONS

The present application claims priority to Chinese patent application No. 2023236199120, filed on Dec. 28, 2023 and entitled “Filter Cartridge Assembly and Water Purification Device,” Chinese patent application No. 202323621492X, filed on Dec. 28, 2023 and entitled “Filter Cartridge Assembly and Water Purification Device,” and Chinese patent application No. 2023236186277, filed on Dec. 28, 2023 and entitled “Filter Cartridge Assembly and Water Purification Device,” which are incorporated herein by reference in their entireties.

### FIELD

The present application relates to the field of water purification, and in particular, to filter cartridge assemblies and water purification devices.

### BACKGROUND

A water purification product is a water purifier, which is a water treatment device that deeply filters and purifies water based on water use requirements. The water purifier can effectively filter out rust, sand, colloids in water, and absorb residual chlorine, odor, discoloration, pesticides and other chemical agents in the water. Bacteria, germs, toxins, heavy metals and other impurities in the water can be effectively removed. The water purifier is widely used in both civil and commercial applications.

In the related field, a connection method between an end cover and a housing body or a support base in a filter cartridge assembly is often achieved by rotating and mounting in a method of rotating and snapping to replace a filter cartridge. Since an end of a filter cartridge provided with a water inlet port and a water outlet port and an end cover connect end are two axially opposite ends, a rotation resistance and a pressure difference between axial inlet and outlet water need to be overcome when replacing the filter cartridge assembly, which makes it difficult for a user to replace the filter cartridge and affects user experience.

A water purifier is a type of equipment that can treat a water source containing impurities and harmful substances to make it pure and drinkable. A main function of the water purifier is to filter out suspended matter, bacteria, viruses, heavy metals and other harmful substances in the water, while retaining minerals and trace elements in the water that are beneficial to human bodies. There are many types of water purifiers. Based on different filtering methods of the water purifiers, the water purifiers can be mainly divided into reverse osmosis water purifiers, ultrafiltration water purifiers, activated carbon water purifiers, ceramic filtration water purifiers, etc. When assembling a water purifier or replacing a filter cartridge, an assembly procedure of the filter cartridge is relatively complicated, resulting in a poor filter cartridge replacement experience.

### BRIEF SUMMARY

The present application aims to solve at least one of the problems existing in the related art. Therefore, the present application provides a filter cartridge assembly, which reduces a screw force required when disassembling and assembling the filter cartridge assembly, thereby making it easier for a user to change a filter cartridge and improving user experience.

Therefore, the present application further provides a filter cartridge assembly, which reduces a mount resistance when assembling the filter cartridge assembly, making it easier for a user to change a filter cartridge and improving user experience.

Therefore, the present application further provides a filter cartridge assembly and a water purification device, which realizes a fast and accurate connection between a filter cartridge and a water path plate interface by providing a limit rib and a limit slot provided with a bell mouth.

The present application further provides a water purification device.

A filter cartridge assembly according to the present application, including:
a filter cartridge base body, where the filter cartridge base body is provided with a mount cavity and a mount port communicating with the mount cavity, an inner wall of the mount port is provided with a guide-out slot, the guide-out slot is provided to extend obliquely along a circumference direction of the mount port, and the guide-out slot communicates with the mount port;
a filter cartridge body, where the filter cartridge body is provided inside the mount cavity, an end of the filter cartridge body is plugged with a water path plate, and another end of the filter cartridge body is provided with a rotatable connector; and
an end cover, where the end cover is correspondingly provided at the mount port, the end cover is rotatably connected to the filter cartridge body through the rotatable connector, an outer peripheral wall of the end cover is provided with a snap protrusion corresponding to the guide-out slot, and the snap protrusion is slidable along the guide-out slot to bring a part of the filter cartridge body away from the mount cavity along an axial direction.

In some embodiments, the snap protrusion is provided with an inclined end surface and an abut protrusion member.

In some embodiments, the abut protrusion member is provided at an end of a side of the inclined end surface close to the guide-out slot.

In some embodiments, the abut protrusion member abuts against and matches with a slot wall of the guide-out slot.

In some embodiments, the guide-out slot includes a guide-out wall.

In some embodiments, the guide-out wall is provided along the circumference direction of the mount port in a streamlined manner.

In some embodiments, the guide-out wall includes a first guide-out segment and a second guide-out segment.

In some embodiments, a radian of the first guide-out segment is greater than a radian of the second guide-out segment.

In some embodiments, a central angle corresponding to an arc length of the first guide-out segment extending along the circumference direction of the mount port is a.

In some embodiments, a is greater than or equal to 10°.

In some embodiments, an inclination angle of the inclined end surface is greater than an inclination angle of the guide-out wall.

In some embodiments, a side of the end cover away from the filter cartridge body is raised to form a grip member.

In some embodiments, an outer peripheral edge of an end of the grip member away from the filter cartridge body protrudes to form an undercut.

In some embodiments, a raise distance H of the grip member along an axial direction of the end cover is greater than or equal to 12 mm.

In some embodiments, an outer peripheral edge of the end cover toward the filter cartridge body is provided with a flange.

In some embodiments, the flange is provided to cover the end of the filter cartridge body provided with the rotatable connector.

In some embodiments, the snap protrusion is provided at an outer wall surface of the flange.

The present application further provides a water purification device, including the filter cartridge assembly. The filter cartridge assembly includes a filter cartridge base body, a filter cartridge body and an end cover. The filter cartridge base body is provided with a mount cavity and a mount port communicating with the mount cavity, an inner wall of the mount port is provided with a guide-out slot, the guide-out slot is provided to extend obliquely along a circumference direction of the mount port, and the guide-out slot communicates with the mount port. The filter cartridge body is provided inside the mount cavity, an end of the filter cartridge body is plugged with a water path plate, and another end of the filter cartridge body is provided with a rotatable connector. The end cover is correspondingly provided at the mount port, the end cover is rotatably connected to the filter cartridge body through the rotatable connector, an outer peripheral wall of the end cover is provided with a snap protrusion corresponding to the guide-out slot, and the snap protrusion is slidable along the guide-out slot to bring a part of the filter cartridge body away from the mount cavity along an axial direction.

One or more of the above solutions in the embodiments of the present application have at least one of the following effects.

In the present application, the guide-out slot is provided at the inner wall of the mount port, and the snap protrusion is provided at the outer peripheral wall of the end cover. Since the guide-out slot extends obliquely along the circumferential direction of the mount port, the snap protrusion matches with the guide-out slot in a point-to-surface manner, to bring the part of the filter cartridge body away from the mount cavity along the axial direction. When the user rotates the end cover, the snap protrusion can slide along the guide-out slot extending along the circumferential direction. Therefore, smoothness and stability of rotational matching between the end cover and the mount port can be enhanced, a pressure difference force, which generates after the filter cartridge body communicates with the water path plate, can be better overcome to separate the water path plate and the filter cartridge body, and part of the filter cartridge body can be brought away from the mount cavity along the axial direction, which can reduce the screw force that the user needs to apply when removing the filter cartridge, thereby making it easier for the user to change the filter cartridge and improving the user experience.

Another filter cartridge assembly according to the present application, including:
a filter cartridge base body, where the filter cartridge base body is provided with a mount cavity and a mount port communicated with the mount cavity, and an inner wall of the mount port is provided with a guide slot;
a filter cartridge body, where the filter cartridge body is provided inside the mount cavity, an end of the filter cartridge body is plugged with a water path plate, and another end of the filter cartridge body is provided with a rotatable connector; and
an end cover, where the end cover is correspondingly provided at the mount port, the end cover is rotatably connected to the filter cartridge body through the rotatable connector, an outer peripheral wall of the end cover is provided with a snap protrusion corresponding to the guide slot, and the snap protrusion is slidable along the guide slot to lock or unlock the filter cartridge body at a position of the mount cavity,
where an inclination angle of a notch end of the guide slot is different from an inclination angle of a guide-in end of the snap protrusion.

In some embodiments, the guide slot includes a first guide surface provided at an entrance end.

In some embodiments, the first guide surface is provided obliquely along a circumference direction of the mount port.

In some embodiments, the snap protrusion includes a second guide surface provided at the guide-in end.

In some embodiments, the second guide surface is provided obliquely along a circumference direction of the end cover.

In some embodiments, an angle α1 between the first guide surface and an axial direction is different from an angle β1 between the second guide surface and a cross section.

In some embodiments, the guide slot further includes a first abut surface.

In some embodiments, the first abut surface is connected to an end of the first guide surface away from a notch.

In some embodiments, the snap protrusion includes a second abut surface.

In some embodiments, the second abut surface is connected to a side of the second guide surface away from the guide-in end.

In some embodiments, the second abut surface extends along the circumference direction of the end cover.

In some embodiments, the first abut surface and the second abut surface abut against each other.

In some embodiments, the angle α1 between the first guide surface and the axial direction is greater than or equal to 30°.

In some embodiments, the angle β1 between the second guide surface and the cross section perpendicular to the axial direction of the end cover is greater than or equal to 30°.

In some embodiments, a slot bottom wall of the guide slot is provided obliquely.

In some embodiments, an angle between the slot bottom wall and a cross section perpendicular to an axial direction of the filter cartridge base body is γ1.

In some embodiments, γ1 is greater than or equal to β1.

In some embodiments, a side of the end cover away from the filter cartridge body is raised to form a grip member.

In some embodiments, a raise distance H1 of the grip member along an axial direction of the end cover is greater than or equal to 12 mm.

In some embodiments, an outer peripheral edge of the end cover toward the filter cartridge body is provided with a flange.

In some embodiments, the flange is provided to cover the end of the filter cartridge body provided with the rotatable connector.

In some embodiments, the snap protrusion is provided at an outer wall surface of the flange.

The present application further provides a water purification device, which includes an outer housing and the filter cartridge assembly. The filter cartridge assembly includes a filter cartridge base body, a filter cartridge body and an end cover. The filter cartridge base body is provided with a mount cavity and a mount port communicated with the mount cavity, and an inner wall of the mount port is provided with a guide slot. The filter cartridge body is provided inside the mount cavity, an end of the filter cartridge body is plugged with a water path plate, and another end of the filter cartridge body is provided with a rotatable connector. The end cover is correspondingly provided at the mount port, the end cover is rotatably connected to the filter cartridge body through the rotatable connector, an outer peripheral wall of the end cover is provided with a snap protrusion corresponding to the guide slot, and the snap protrusion is slidable along the guide slot to lock or unlock the filter cartridge body at a position of the mount cavity. An inclination angle of a notch end of the guide slot is different from an inclination angle of a guide-in end of the snap protrusion.

One or more of the above solutions in the embodiments of the present application have at least one of the following effects.

In the present application, the inclination angle of the notch end of the guide slot is different from the inclination angle of the guide-in end of the snap protrusion, so that when the filter cartridge assembly is assembled, an original surface-to-surface contact between the guide-in end of the snap protrusion and a notch of the guide slot is replaced by a contact between an abut point and an abut surface, which makes it easier for the snap protrusion to slide along the guide slot, thereby reducing the mount resistance. Due to a special design for the guide slot and the snap protrusion, a position of the filter cartridge body can be more easily adjusted and locked, so that the user can save more effort when replacing the filter cartridge, thereby improving the user experience.

A filter cartridge assembly provided by the present application, including:
a filter cartridge body, where an outer peripheral wall of the filter cartridge body is provided with a limit rib; and
a filter cartridge mount seat, where a mount cavity is provided inside the filter cartridge mount seat, a side of the mount cavity is provided with an opening, the filter cartridge body is able to be mounted at the mount cavity through the opening, an inner wall of the mount cavity is provided with a limit slot, the limit rib is slidable along the limit slot, matching between the limit rib and the limit slot is used to limit rotation of the filter cartridge body in a circumferential direction of the filter cartridge body, an end of the limit slot is provided with a bell mouth, and the bell mouth communicates with the opening.

In some embodiments, a plurality of limit ribs are provided, and the plurality of limit ribs are spaced apart along the circumferential direction of the filter cartridge body.

In some embodiments, a width of the limit rib is 2 mm to 5 mm.

In some embodiments, the limit rib is in a shape of straight line.

In some embodiments, an end of the limit rib is provided with a guide slope.

In some embodiments, the filter cartridge body includes:
a body member, where the limit rib is provided at an outer peripheral wall of the body member, the body member is provided inside the mount cavity, and the body member is slidable along a length direction of the limit slot; and
a cover body, where the cover body covers an end of the body member, a part of the cover body is located inside the opening, and the cover body is rotatable relative to the body member.

In some embodiments, in a length direction of the limit rib, a width of the cover body is less than a length of the limit rib.

In some embodiments, the cover body is provided with a rotation convex strip.

In some embodiments, an inner peripheral wall of the mount cavity is provided with a rotation groove.

In some embodiments, the rotation groove extends along a circumferential direction of the body member.

In some embodiments, the limit slot extends along a length direction of the body member.

In some embodiments, under matching between the rotation convex strip and the rotation groove, and matching between the limit slot and the limit rib, and the cover body and the body member move along a direction of the limit slot while the cover body rotates relative to the body member.

In some embodiments, an opening of the rotation groove communicates with the bell mouth.

The present application further provides a water purification device, including:
a filter cartridge assembly, where the filter cartridge assembly is the filter cartridge assembly described above; and
a machine housing, where the filter cartridge assembly is provided inside the machine housing, the machine housing and the filter cartridge mount seat of the filter cartridge assembly are integrally formed, and an opening of the filter cartridge assembly is provided at the machine housing.

In the filter cartridge assembly and the water purification device according to the embodiments of the present application, a movement range of the limit rib is limited by utilizing the limit function of the limit slot, thereby limiting a movement range of the filter cartridge body. Further, by providing the bell mouth at an end of the limit slot, not only the limit rib can be guided to fit inside the limit slot by a guide function of the bell mouth, but also the bell mouth has advantages of wide mouth inlet and narrow mouth outlet, thereby facilitating the limit rib to fit inside the limit slot.

Additional aspects and advantages of the present application will be set forth in part in the description which follows and, in part, will be apparent from the description, or may be learned by practice of the presented application.

### BRIEF DESCRIPTION OF THE DRAWINGS

In order to clearly illustrate the solutions according to the present application, the accompanying drawings used in the description of the embodiments of the present application are briefly introduced below. It should be noted that, the drawings in the following description are only part embodiments of the present application. For those of ordinary skill in the art, other drawings may also be obtained based on these drawings without creative efforts.

FIG. 1 is a schematic structural diagram of a water purification device according to an embodiment of the present application;

FIG. 2 is a partial cross-sectional view of a filter cartridge assembly during assembly according to an embodiment of the present application;

FIG. 3 is an enlarged view of A of FIG. 2;

FIG. 4 is a schematic structural diagram of a housing body of FIG. 1;

FIG. 5 is a partial enlarged view of a mount port of FIG. 1;

FIG. 6 is a schematic assembly diagram of a filter cartridge body and an end cover;

FIG. 7 is a schematic assembly diagram of the filter cartridge body and the end cover of FIG. from another perspective;

FIG. 8 is a schematic structural diagram of a water purification device according to an embodiment of the present application;

FIG. 9 is a partial cross-sectional view of a filter cartridge assembly during assembly according to an embodiment of the present application;

FIG. 10 is an enlarged view of A1 of FIG. 9;

FIG. 11 is a cross-sectional view of a housing body of FIG. 8;

FIG. 12 is a schematic assembly diagram of a filter cartridge body and an end cover;

FIG. 13 is a partial schematic structural diagram of a water purification device according to an embodiment of the present application;

FIG. 14 is a partial schematic structural diagram of FIG. 13;

FIG. 15 is a cross-sectional view of a water purification device according to an embodiment of the present application;

FIG. 16 is a partial schematic structural diagram of FIG. 15;

FIG. 17 is a schematic structural diagram of a filter cartridge body of a water purification device according to an embodiment of the present application; and

FIG. 18 is a schematic structural diagram of a filter cartridge body of a water purification device according to an embodiment of the present application.

### REFERENCE NUMERALS

10: water purification device;
100: filter cartridge assembly;
110: filter cartridge base body; 111: mount cavity; 112: mount port; 113: guide-out slot; 113a: guide-out wall; 113b: first guide-out segment; 113c: second guide-out segment;
120: filter cartridge body;
130: end cover; 131: snap protrusion; 131a: inclined end surface; 131b: abut protrusion member; 132: grip member; 132a: undercut; 133: flange;
200: outer housing.
1-10: water purification device;
1-100: filter cartridge assembly;
1-110: filter cartridge base body; 1-111: mount cavity; 1-112: mount port; 1-113: guide slot; 1-113a: first guide surface; 1-113b: first abut surface; 1-113c: slot bottom wall;
1-120: filter cartridge body;
1-130: end cover; 1-131: snap protrusion; 1-131a: second guide surface; 1-131b: second abut surface; 1-132: grip member; 1-133: flange;
1-200: outer housing.
2-1000: water purification device; 2-200: machine housing; 2-100: filter cartridge assembly;
2-110: filter cartridge body; 2-111: limit rib; 2-112: guide slope; 2-113: body member; 2-114: cover body; 2-115: rotation convex strip; 2-116: water outlet tube; 2-117: handle member;
2-120: filter cartridge mount seat; 2-121: mount cavity; 2-122: opening; 2-123: limit slot; 2-124: bell mouth; 2-125: rotation groove.

### DETAILED DESCRIPTION

Implementations of the present application are further described in detail below with reference to the drawings and embodiments. The following embodiments are intended to illustrate the present application, but are not intended to limit the scope of the present application.

In the description of the embodiments of the present application, it should be noted that the orientation or positional relationship indicated by terms such as “center,” “longitudinal,” “lateral,” “upper,” “lower,” “front,” “rear,” “left,” “right,” “vertical,” “horizontal,” “top,” “bottom,” “inside,” “outside,” etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first,” “second,” “third,” and the like are used for descriptive purposes only and are not to be construed as indicating or implying relative importance.

In the description of the present application, it should be noted that, unless explicitly specified and defined otherwise, the terms “connected to” and “connected” shall be understood broadly, for example, it may be either fixedly connected or detachably connected, or may be integrated; it may be either mechanically connected, or electrically connected; it may be either directly connected, or indirectly connected through an intermediate medium. The specific meanings of the terms above in embodiments of the present application can be understood by a person skilled in the art in accordance with specific conditions.

In the embodiments of the present application, unless otherwise clearly stated and defined, a first feature being located “on” or “under” a second feature means that the first feature is in direct contact with the second feature or the first feature is in contact with the second feature by an intervening media. In addition, the first feature is “on,” “above” and “over” the second feature may refer to that the first feature is directly above or obliquely above the second feature, or simply refer to that the level height of the first feature is higher than that of the second feature. The first feature is “under,” “below” and “beneath” the second feature may refer to that the first feature is directly below or obliquely below the second feature, or simply refer to that the level height of the first feature is lower than that of the second feature.

In the description of this specification, the description with reference to the terms “an embodiment,” “some embodiments,” “example,” “specific example,” or “some examples” etc. means that the specific features, structures, materials or characteristics described in conjunction with the embodiment or example are included in at least one embodiment or example of the embodiments of the present application. In this specification, the schematic representations of the above terms do not necessarily refer to the same embodiment or example. Moreover, the specific features, structures, materials or characteristics described may be combined in any one or more embodiments or examples in a suitable manner. In addition, those skilled in the art may integrate and combine the different embodiments or examples described in this specification and the features of the different embodiments or examples, without contradiction.

A water purification product is a water purifier, which is a piece of water treatment equipment that deeply filters and purifies water based on water use requirements. The water purifier can effectively filter out rust, sand, colloids in water, and absorb residual chlorine, odor, discoloration, pesticides and other chemical agents in the water. Bacteria, germs, toxins, heavy metals and other impurities in the water can be effectively removed. The water purification product is widely used in both civil and commercial applications.

In the related field, a connection method between an end cover and a housing body or a support base in a filter cartridge assembly is often achieved by rotating and mounting in a method of rotating and snapping to replace a filter cartridge. Since an end of a filter cartridge provided with a water inlet port and a water outlet port and an end cover connect end are two axially opposite ends, a rotation resistance and a pressure difference between axial inlet and outlet water need to be overcome when replacing the filter cartridge assembly, which makes it difficult for a user to replace the filter cartridge and affects user experience.

The present application provides a filter cartridge assembly and a water purification device.

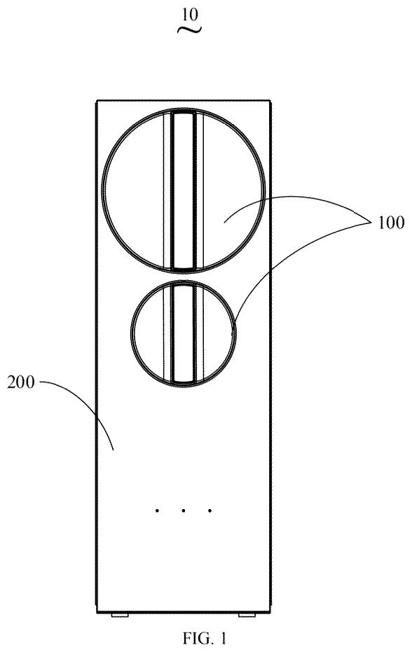

In the embodiment of the present application, as shown in FIG. 1 to FIG. 3, the filter cartridge assembly 100 includes a filter cartridge base body 110, a filter cartridge body 120 and an end cover 130. The filter cartridge base body 110 is provided with a mount cavity 111 and a mount port 112 communicating with the mount cavity 111, an inner wall of the mount port 112 is provided with a guide-out slot 113, the guide-out slot 113 is provided to extend obliquely along a circumference direction of the mount port 112, and the guide-out slot 113 communicates with the mount port 112. The filter cartridge body 120 is provided inside the mount cavity 111, an end of the filter cartridge body 120 is plugged with a water path plate, and another end of the filter cartridge body 120 is provided with a rotatable connector. The end cover 130 is correspondingly provided at the mount port 112, and the end cover 130 is rotatably connected to the filter cartridge body 120 through the rotatable connector, an outer peripheral wall of the end cover 130 is provided with a snap protrusion 131 corresponding to the guide-out slot 113, and the snap protrusion 131 is slidable along the guide-out slot 113 to bring a part of the filter cartridge body 120 away from the mount cavity 111 along an axial direction.

The filter cartridge base body 110 may be a mount support base provided separately from an outer housing 200 or may be integrally formed with the outer housing 200. A mount base body is formed with the mount cavity 111 and the mount port 112 communicating with the mount cavity 111, and the mount cavity 111 provides a stable mount space for the filter cartridge body 120. The mount port 112 makes the filter cartridge body 120 be easily inserted and removed. It also ensures that water or other fluids can flow into and pass through the filter cartridge body 120. An inner wall of the mount port 112 is provided with a plurality of axisymmetric guide slots. The guide slot provides directional guidance to make the snap protrusion 131 at the end cover 130 be able to accurately slide into the guide slot, thereby ensuring a correct mount position of the filter cartridge body 120.

The filter cartridge body 120 is provided inside the mount cavity 111, and an end of the filter cartridge body 120 is plugged with the water path plate, which simultaneously facilitates mounting between the water path plate and the filter cartridge body 120, and simplifies a structural design of the water path plate, thereby reducing production costs. Another end of the filter cartridge body 120 is provided with a rotatable connector, thereby allowing the end cover 130 to be rotatably connected to the filter cartridge body 120. Therefore, the filter cartridge body 120 and the water path plate can be limited in an axial direction by the end cover 130, so that the filter cartridge body 120 does not need to be rotated during fixing procedure, which saves a matched rotate structure provided at the water path plate, further simplifies a structure of the water path plate, and facilitate a user to operate.

The end cover 130 is correspondingly provided at the mount port 112, and the end cover 130 is rotatably connected to the filter cartridge body 120 through the rotatable connector, to ensure that the end cover 130 can tightly cover the mount port 112. When the filter cartridge assembly 100 is mounted at a water path system, the end cover 130 can tightly fix the filter cartridge body 120 in the mount cavity 111 of the filter cartridge base body 110. The filter cartridge body 120 can be prevented from rotating or moving during operation, thereby ensuring the normal operation of the filter cartridge assembly 100. Meanwhile, when the filter cartridge assembly 100 needs to be replaced, by rotating the end cover 130, the snap protrusion 131 slides along the guide-out slot 113, thereby bring the filter cartridge body 120 to move along an axis toward the mount port 112. The snap protrusion 131 slidably abuts against the guide-out slot 113, to better overcome a pressure difference force generated between the filter cartridge body 120 and the water path plate, so that the filter cartridge body 120 can be removed from the mount cavity 111 more labor-saving.

In the present application, the guide-out slot 113s provided at the inner wall of the mount port 112, and the snap protrusion 131 is provided at the outer peripheral wall of the end cover 130. Since the guide-out slot 113 extends along the circumferential direction of the mount port 112, the snap protrusion 131 matches with the guide-out slot 113 in a point-to-surface manner, to bring the part of the filter cartridge body away from the mount cavity 111 along the axial direction. When the user rotates the end cover 130, the snap protrusion 131 can slide along the guide-out slot 113 extending along the circumferential direction. Therefore, smoothness and stability of rotational matching between the end cover 130 and the mount port 112 can be enhanced, a pressure difference force, which generates after the filter cartridge body communicates with the water path plate, can be better overcome to separate the water path plate and the filter cartridge body 120, and the part of the filter cartridge body 120 can brought away from the mount cavity 111 along the axial direction, which can reduce the screw force that the user needs to apply when removing the filter cartridge, thereby making it easier for the user to change the filter cartridge and improving the user experience.

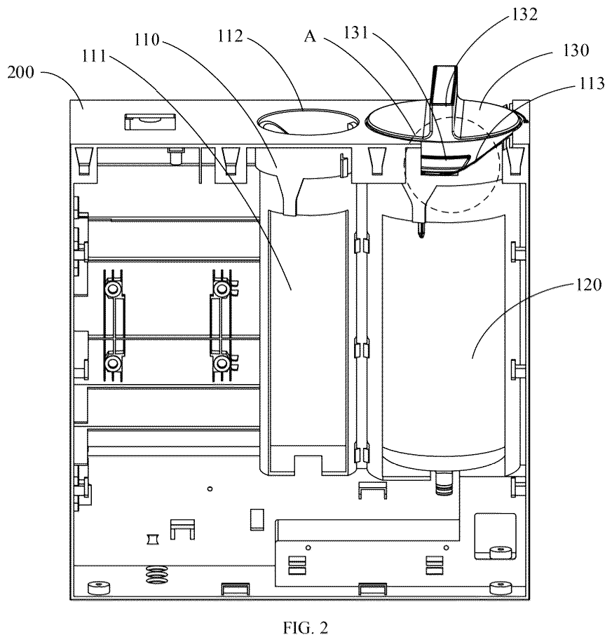

Referring to FIG. 2 to FIG. 6, in some embodiments, the snap protrusion 131 is provided with an inclined end surface 131a and an abut protrusion member 131b. The abut protrusion member 131b is provided at an end of a side of the inclined end surface 131a close to the guide-out slot 113, and the abut protrusion member 131b abuts against and matches with a slot wall of the guide-out slot 113. In this embodiment, the abut protrusion member 131b is a rounded protrusion structure, which can slidably abut against and matches with part of the slot wall of the guide-out slot 113, reduce a contact area between the snap protrusion 131 and the guide-out slot 113, and reduce a friction resistance. Therefore, a rotation force required by the user when disassembling and assembling the filter cartridge assembly 100 is reduced, and the use convenience for the user is improved.

Referring to FIG. 2 to FIG. 4, in some embodiments, the guide-out slot 113 includes a guide-out wall 113a. The guide-out wall 113a is provided along the circumference direction of the mount port 112 in a streamlined manner. The guide-out wall 113a includes a first guide-out segment 113b and a second guide-out segment 113c, and a radian of the first guide-out segment 113b is greater than a radian of the second guide-out segment 113c. In an embodiment, providing the guide-out wall 113a in a streamlined manner can improve the smoothness of the rotational matching between the snap protrusion 131 and the guide-out slot 113, so that the snap protrusion 131 passes through the guide-out slot 113 more smoothly. Since it is necessary to overcome a pressure difference between the water path plate and the filter cartridge body 120 in an early stage of disassembling the filter cartridge body 120, in this embodiment, the first guide-out segment 113b is provided as a curved surface with a larger radian, so that when the snap protrusion 131 slides along the first guide-out segment 113b, a displacement distance of the filter cartridge body 120 along the axis is increased, and the pressure difference is better overcome. Relative to the radian of the first guide-out segment 113b, the radian of the second guide-out segment 113c tends to be gentle, so that the snap protrusion 131 can gradually slide out of the guide-out slot 113 and guide the end cover 130 to be out of the mount port 112. Therefore, while improving an assembly efficiency of the filter cartridge assembly 100, a risk of damage caused by an improper operation or an excessive force can also be reduced.

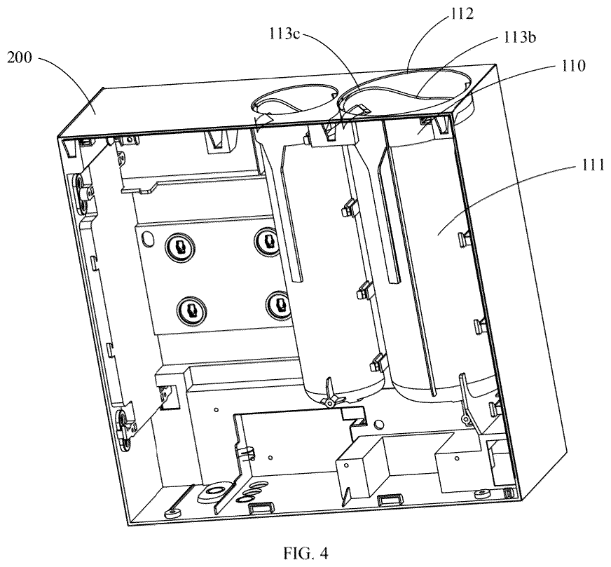

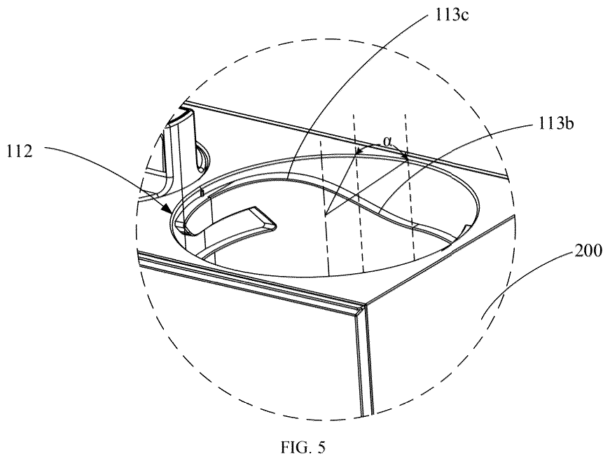

Specifically, referring to FIG. 4 and FIG. 5, in some embodiments, a central angle corresponding to an arc length of the first guide-out segment 113b extending circumferentially along the mount port 112 is α. α is greater than or equal to 10°. In an embodiment, the size of the central angle corresponding to the arc length of the first guide-out segment 113b extending circumferentially along the mount port 112 is closely related to the radian of the first guide-out segment 113b and a length of a plug column between an interface of the filter cartridge body 120 and the water path plate. The longer the length of the plug column, the greater the distance that the filter cartridge body 120 needs to be axially displaced, and the larger the central angle α corresponding to the first guide-out segment 113b, the greater the axial distance when the snap protrusion 131 slides in the first guide-out segment 113b. Therefore, the size of the central angle corresponding to the arc length of the first guide-out segment 113b extending circumferentially along the mount port 112 can be set based on the length of the plug column between the interface of the filter cartridge body 120 and the water path plate. The longer the length of the plug column, the larger the central angle corresponding to the arc length of the first guide-out segment 113b extending circumferentially along the mount port 112. Therefore, a matching ejection distance between a snap boss and the guide-out slot 113 can be increased by increasing the size of the central angle of the first guide-out segment 113b, which reduces the rotational force to be applied, so that the user can perform a filter cartridge replacement operation more labor-savingly.

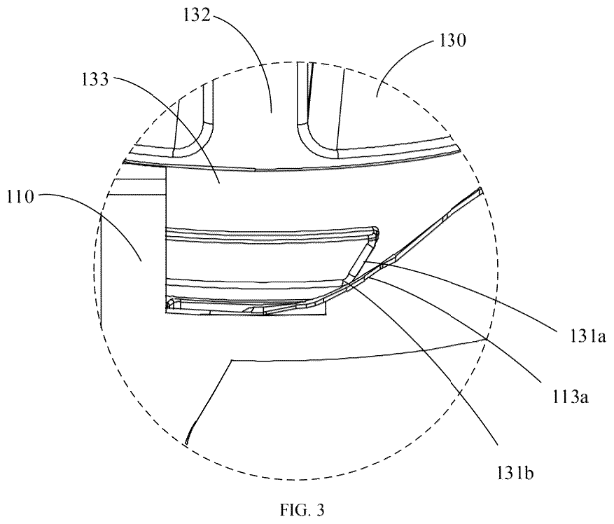

Referring to FIG. 3, in some embodiments, an inclination angle of the inclined end surface 131a is greater than an inclination angle of the guide-out wall 113a. In an embodiment, the inclination angle of the inclined end surface 131a is greater than the inclination angle of the guide-out wall 113a, thereby achieving an avoidance of the inclined end surface 131a to the guide-out wall 113a, so that the snap protrusion 131 slidably abuts against the guide-out wall 113a only through the abut protrusion member 131b, and a friction and a resistance generated during a sliding procedure are reduced. A structural strength of the abut protrusion member can also be enhanced simultaneously.

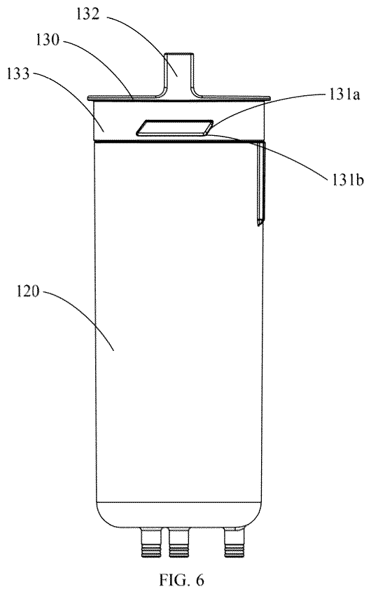

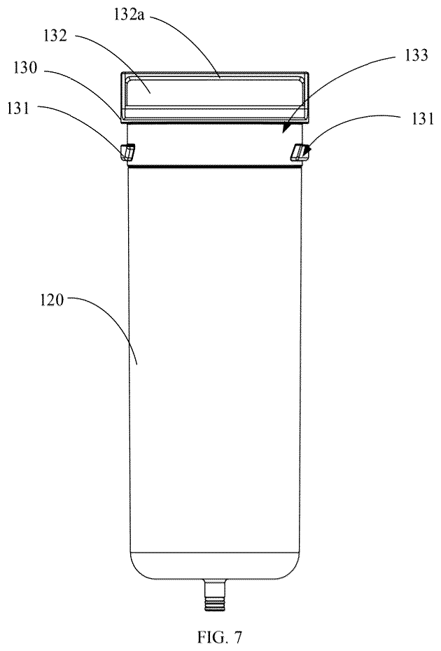

Referring to FIG. 2, FIG. 6 and FIG. 7, in some embodiments, a side of the end cover 130 away from the filter cartridge body 120 is raised to form a grip member 132. In this embodiment, a part of the end cover 130 protrudes in a direction away from the filter cartridge body 120 to form a gripable shape, so that an operator can easily hold the end cover 130 and operate it. The side of the end cover 130 away from the filter cartridge body 120 is raised to form the grip member 132, so that a handle can be provided for the operator who replaces or assembles the filter cartridge to grip. The shape of the grip member 132 can be a shape suitable for sizes of human hands, such as a circle, a rectangle or a semicircle, so that the operator can easily hold and operate it.

Referring to FIG. 7, in some embodiments, an outer peripheral edge of an end of the grip member 132 away from the filter cartridge body 120 protrudes to form an undercut 132a. In an embodiment, a structure of the undercut 132a can make it easier for the user to grip the filter cartridge, especially when the grip member 132 is protruding, the user can more conveniently grasp the filter cartridge, so that it is easier to mount, replace or handle the filter cartridge. In addition, by designing the undercut 132a structure at the grip member 132, the convenience of the user in operating the filter cartridge can be improved. Whether mounting the filter cartridge into a piece of equipment or replacing the filter cartridge, the structure of the undercut 132a allows the user to grip the filter cartridge more easily and firmly, thereby improving user-friendliness of a product. The user may feel more comfortable and convenient when using the filter cartridge, thereby improving the overall user experience.

Specifically, a raise distance of the grip member 132 along an axial direction of the end cover 130 is greater than or equal to 12 mm. In an embodiment, a larger raise distance of the grip member 132 can provide a better handle lever, allowing the user to better control and operate the filter cartridge. The larger raise distance can provide a better grip force and comfort experience. Specifically, the raise distance can be selected based on the size of the filter cartridge or arrangement requirements, which is not specifically limited here.

Referring to FIG. 6, in some embodiments, an outer periphery edge of the end cover 130 toward the filter cartridge body 120 is provided with a flange 133, the flange 133 is provided to cover the end of the filter cartridge body 120 provided with the rotatable connector, and the snap protrusion 131 is provided at an outer wall surface of the flange 133. In an embodiment, by providing the flange 133, the end cover 130 can cover an end of the filter cartridge body 120 and provide an embedded space to accommodate the rotatable connector of the filter cartridge body 120. By combining the rotatable connector and the end cover 130, the end cover 130 can be firmly fixed on the filter cartridge body 120. Meanwhile, the flange 133 can further provide a position for providing the snap protrusion 131.

The present application further provides a water purification device 10, and the water purification device 10 includes an outer housing 200 and a filter cartridge assembly 100. A specific structure of the filter cartridge assembly 100 refers to the above embodiments. Since the present water purification device 10 adopts all the solutions of all the above embodiments, it at least has all the beneficial effects brought by the solutions of the above embodiments, which will not be described one by one here.

The present application further provides a filter cartridge assembly and a water purifier.

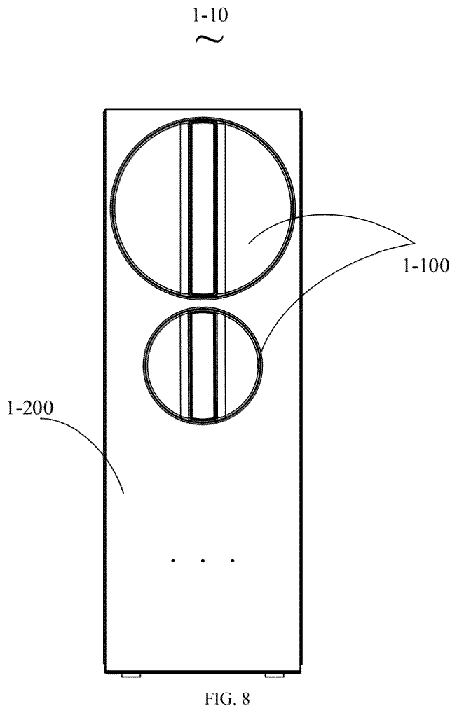

In the embodiment of the present application, as shown in FIG. 8 to FIG. 10, the filter cartridge assembly 1-100 includes a filter cartridge base body 1-110, a filter cartridge body 1-120 and an end cover 1-130, the filter cartridge base body 1-110 is provided with a mount cavity 1-111 and a mount port 1-112 communicated with the mount cavity 1-111, and an inner wall of the mount port 1-112 is provided with a plurality of axisymmetric guide slots 1-113. The filter cartridge body 1-120 is provided inside the mount cavity 1-111, an end of the filter cartridge body 1-120 is plugged with the water path plate, and another end of the filter cartridge body 1-120 is provided with a rotatable connector. The end cover 1-130 is correspondingly provided at the mount port 1-112, the end cover 1-130 is rotatably connected to the filter cartridge body 1-120 through the rotatable connector, an outer peripheral wall of the end cover 1-130 is provided with a snap protrusion 1-131 corresponding to the guide slot 1-113, and the snap protrusion 1-131 is slidable along the guide slot 1-113 to lock or unlock the filter cartridge body 1-120 at a position of the mount cavity 1-111. An inclination angle of a notch end of the guide slot 1-113 is different from an inclination angle of a guide-in end of the snap protrusion 1-131.

The filter cartridge base body 1-110 may be a mount support base provided separately from an outer housing 1-200 or may be integrally formed with the outer housing 1-200. A mount base body is formed with a mount cavity 1-111 and a mount port 1-112 communicated with the mount cavity 1-111, and the mount cavity 1-111 provides a stable mount space for the filter cartridge body 1-120. The mount port 1-112 makes the filter cartridge body 1-120 to be easily inserted and removed. It also ensures that water or other fluids can flow into and pass through the filter cartridge body 1-120. An inner wall of the mount port 1-112 is provided with a plurality of axisymmetric guide slots 1-113. The guide slot 1-113 provides directional guidance to make the snap protrusion 1-131 at the end cover 1-130 be able to accurately slide into the guide slot 1-113, ensuring a correct mount position of the filter cartridge body 1-120.

The filter cartridge body 1-120 is provided inside the mount cavity 1-111, and an end of the filter cartridge body 1-120 is plugged with the water path plate, which simultaneously facilitates mounting between the water path plate and the filter cartridge body 1-120, and simplifies a structural design of the water path plate, thereby reducing production costs. Another end of the filter cartridge body 1-120 is provided with a rotatable connector, thereby allowing the end cover 1-130 to be rotatably connected to the filter cartridge body 1-120. Therefore, the filter cartridge body 1-120 and the water path plate can be limited in an axial direction by the end cover 1-130, so that the filter cartridge body 1-120 does not need to be rotated during fixing procedure, which saves a matched rotate structure provided at the water path plate, further simplifies a structure of the water path plate, and facilitate a user to operate.

The end cover 1-130 is correspondingly provided at the mount port 1-112, and the end cover 1-130 is rotatably connected to the filter cartridge body 1-120 through the rotatable connector, to ensure that the end cover 1-130 can tightly cover the mount port 1-112, and the filter cartridge body 1-120 is separated from the water path plate. The outer peripheral wall of the end cover 1-130 is provided with a snap protrusion 1-131 corresponding to the guide slot 1-113. The snap protrusion 1-131 is slidable along the guide slot 1-113. When the end cover 1-130 is rotated to a correct position, the snap protrusion 1-131 will slide into the guide slot 1-113, thereby locking the end cover 1-130 in the correct position, to ensure stability and safety of the end cover 1-130. The inclination angle of the notch end of the guide slot 1-113 is different from the inclination angle of the guide-in end of the snap protrusion 1-131. Therefore, when the snap protrusion 1-131 slides into the guide slot 1-113, the inclination angle of the guide-in end of the snap protrusion 1-131 is different from the inclination angle of the notch end of the guide slot 1-113, which makes sliding procedure smoother and reduces a mount resistance.

In the present application, the inclination angle of the notch end of the guide slot 1-113 is different from the inclination angle of the guide-in end of the snap protrusion 1-131, so that when the filter cartridge assembly 1-100 is assembled, an original surface-to-surface contact between the guide-in end of the snap protrusion 1-131 and a notch of the guide slot 1-113 is replaced by a contact between an abut point and an abut surface, which makes it easier for the snap protrusion 1-131 to slide along the guide slot 1-113, thereby reducing the mount resistance. Due to a special design of the guide slot 1-113 and the snap protrusion 1-131, a position of the filter cartridge body 1-120 can be more easily adjusted and locked, so that the user can save more effort when replacing the filter cartridge, thereby improving the user experience.

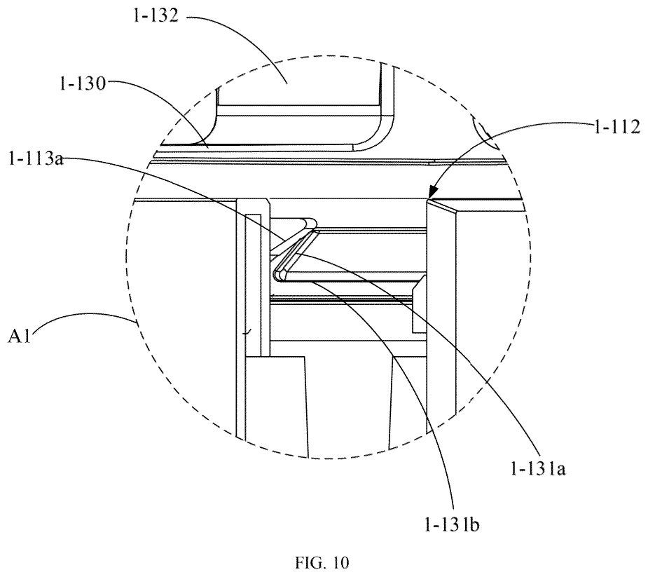

Referring to FIG. 10 to FIG. 12, in some embodiments, the guide slot 1-113 includes a first guide surface 1-113a provided at an entrance end, and the first guide surface 1-113a is provided obliquely along a circumference direction of the mount port 1-112. The snap-fit protrusion 1-131 includes a second guide surface 1-131a provided at the guide-in end, and the second guide surface 1-131a is provided obliquely along a circumference direction of the end cover 1-130. An angle α1 between the first guide surface 1-113a and an axial direction is different from an angle β1 between the second guide surface 1-131a and a cross section. In this embodiment, the entrance end of the guide slot 1-113 and the guide-in end of the snap protrusion 1-131 are correspondingly provided with a first guide surface 1-113a and a second guide surface 1-131a having different inclinations. An inclination angle of the first guide surface 1-113a may be greater than an inclination angle of the second guide surface 1-131a, or an inclination angle of the first guide surface 1-113a may be less than an inclination angle of the second guide surface 1-131a. Therefore, by providing the inclination angle of one guide surface to be larger and the inclination angle of the other guide surface to be smaller, surface to surface abutting against and matching generated between the first guide surface 1-113a and the second guide surface 1-131a can be prevented, which is replaced by sliding matching between points and surfaces, thereby effectively reducing a friction, reducing a resistance during connection, and improving smoothness of connection.

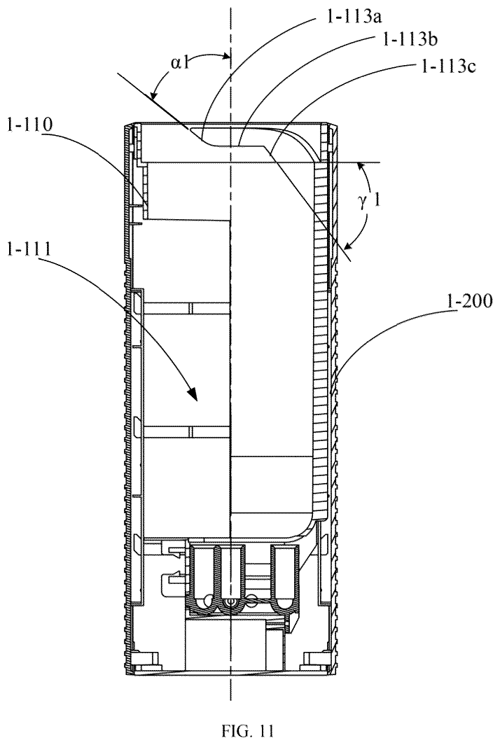

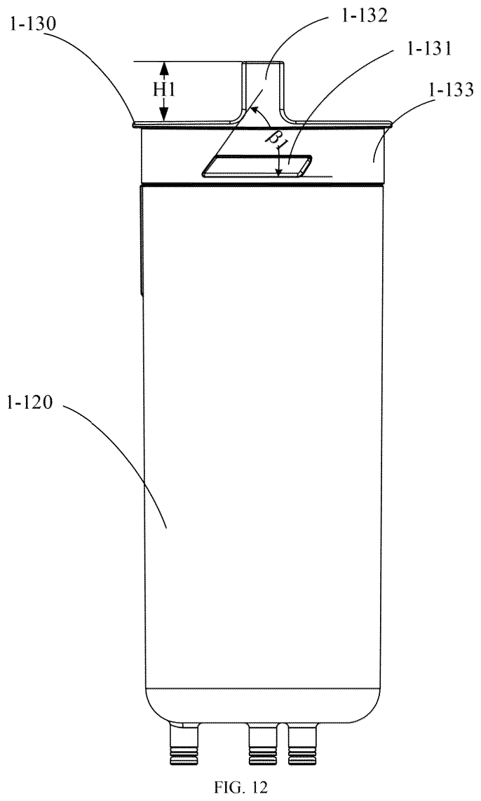

Referring to FIG. 11 and FIG. 12, in some embodiments, the guide slot 1-113 further includes a first abut surface 1-113b, and the first abut surface 1-113b is connected to an end of the first guide surface 1-113a away from a notch. The snap protrusion 1-131 includes a second abut surface 1-131b, and the second abut surface 1-131b is connected to a side of the second guide surface 1-131a away from the guide-in end. The second abut surface 1-131b extends along the circumference direction of the end cover 1-130, and the first abut surface 1-113b and the second abut surface 1-131b abut against each other. In an embodiment, during the use of the filter cartridge body 1-120, since the water path is provided at a plug end of the water path plate, the filter cartridge body 1-120 gives the end cover 1-130 an axial force away from an end of the water path. In order to improve an axial abutment force between the end cover 1-130 and the filter cartridge base body 1-110, an end of the first guide surface 1-113a facing a slot bottom is provided with the first abut surface 1-113b, and the snap protrusion 1-131 is provided with the second abut surface 1-131b. When the snap protrusion 1-131 is locked with the guide slot 1-113, the first abut surface 1-113b abuts against and matches with the second abut surface 1-131b, to provide an axial abutment force for the end cover 1-130, thereby fixing the filter cartridge body 1-120 inside the mount cavity 1-111, and improving connection stability and reliability of the filter cartridge assembly 1-100.

Referring to FIG. 11, in some embodiments, the angle α1 between the first guide surface 1-113 a and the axial direction is greater than or equal to 30°. In an embodiment of the present application, the size of the angle α1 between the first guide surface 1-113a and the axial direction affects a thickness of a slot wall of the corresponding guide slot 1-113. The smaller the angle α1 between the first guide surface 1-113a and the axial direction, the smaller the thickness of the slot wall corresponding to the first guide surface 1-113a. A smaller wall thickness leads to a weakened structural strength, which is not conducive to repeated mounting with the filter cartridge assembly 1-100, and cannot ensure the stability and reliability of a connection. Therefore, in this embodiment, the angle α1 between the first guide surface 1-113a and the axial direction is limited to be greater than or equal to 30°, to ensure the wall thickness of the slot wall corresponding to the first guide surface 1-113a and a structural strength of the guide slot 1-113.

Referring to FIG. 12, in some embodiments, the angle β1 between the second guide surface 1-131a and the cross section perpendicular to the axial direction of the end cover 1-130 is greater than or equal to 30°. In an embodiment of the present application, the size of the angle β1 between the second guide surface 1-131a and the cross section also affects an axial thickness of the corresponding snap protrusion 1-131. The smaller the angle B1 between the second guide surface 1-131a and the cross section, the smaller the axial thickness corresponding to the second guide surface 1-131a. A smaller wall thickness leads to a weakened structural strength, which is not conducive to repeated mounting with the filter cartridge assembly 1-100, and cannot ensure the stability and reliability of the connection. Therefore, in this embodiment, the angle β1 between the second guide surface 1-131 a and the cross section is limited to be greater than or equal to 30°, to ensure the axial thickness of the snap protrusion 1-131 corresponding to the second guide surface 1-131a and a structural strength of the snap protrusion 1-131.

Referring to FIG. 11 and FIG. 12, in some embodiments, a slot bottom wall 1-113c of the guide slot 1-113 is provided obliquely, and the angle between the slot bottom wall 1-113c and a cross section perpendicular to an axial direction of the filter cartridge base body 120 is γ1, where γ1 is greater than or equal to β1. In an embodiment, when the snap protrusion 1-131 slides into a bottom of the guide slot 1-113, that is, locking between the end cover 1-130 and the mount port 1-112 is completed. In this embodiment, the slot bottom wall 1-113c at the bottom of the guide slot 1-113 is provided to have an inclined angle that is adapted to the second guide surface 1-131a corresponding to the snap protrusion 1-131 after being snapped and fixed, so that the guide slot 1-113 can be snapped and matched with the snap protrusion 1-131. In other embodiments, the slot bottom wall 1-113c can also be provided to have a greater inclination than the inclination angle of the second guide surface 1-131a, thereby improving matching extent of the guide slot 1-113 to the snap protrusions 1-131 having different inclinations, and increasing applicability of the guide slot 1-113.

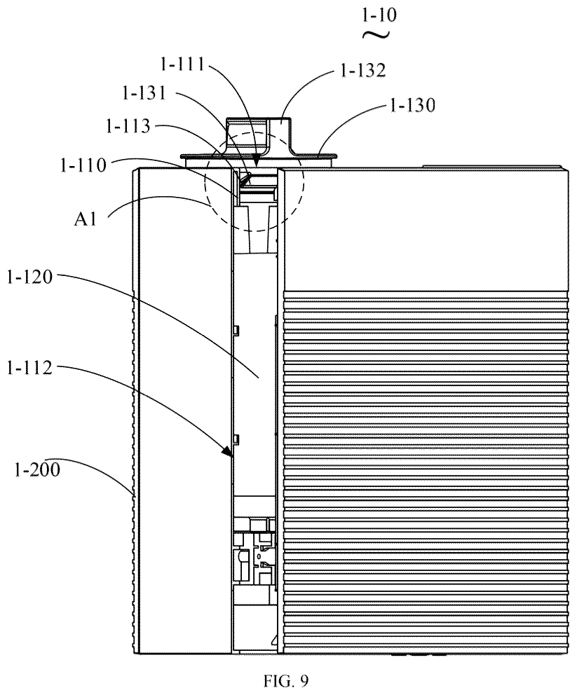

Referring to FIG. 9 and FIG. 11, in some embodiments, a side of the end cover 1-130 away from the filter cartridge body 1-120 is raised to form a grip member 1-132. In this embodiment, a part of the end cover 1-130 protrudes in a direction away from the filter cartridge body 1-120 to form a gripable shape, so that an operator can easily hold the end cover 1-130 and operate it. The side of the end cover 1-130 away from the filter cartridge body 1-120 is raised to form the grip member 1-132, so that a handle can be provided for the operator who replaces or assembles the filter cartridge to grip. The shape of the grip member 1-132 can be a shape suitable for sizes of human hands, such as a circle, rectangle or semicircle, so that the operator can easily hold and operate it.

Specifically, a raise distance H1 of the grip member 1-132 along an axial direction of the end cover 1-130 is greater than or equal to 12 mm. In an embodiment, a larger raise distance of the grip member 1-132 can provide a better handle lever, allowing the user to better control and operate the filter cartridge. The larger raise distance can provide a better grip force and comfort experience. Specifically, the raise distance can be selected based on the size of the filter cartridge or arrangement requirements, which is not specifically limited here.

Referring to FIG. 12, in some embodiments, an outer periphery edge of the end cover 1-130 toward the filter cartridge body 1-120 is provided with a flange 1-133, the flange 1-133 is provided to cover the end of the filter cartridge body 1-120 provided with the rotatable connector, and the snap protrusion 1-131 is provided at an outer wall surface of the flange 1-133. In an embodiment, by providing the flange 1-133, the end cover 1-130 can cover an end of the filter cartridge body 1-120 and provide an embedded space to accommodate the rotatable connector of the filter cartridge body 1-120. By combining the rotatable connector and the end cover 1-130, the end cover 1-130 can be firmly fixed on the filter cartridge body 1-120. Meanwhile, the flange 1-133 can further provide a position for providing the snap protrusion 1-131.

The present application further provides a water purification device 1-10, and the water purification device 1-10 includes an outer housing 1-200 and a filter cartridge assembly 1-100. A specific structure of the filter cartridge assembly 1-100 refers to the above embodiments. Since the present water purification device 1-10 adopts all the solutions of all the above embodiments, it at least has all the beneficial effects brought by the solutions of the above embodiments, which will not be described one by one here.

A filter cartridge assembly 2-100 and a water purification device 2-1000 according to the embodiments of the present application is described below with reference to the drawings. It should be noted that the water purification device 2-1000 can be a water purifier, and the filter cartridge assembly 2-100 is provided inside the water purifier for filtering water. A water purifier is a type of equipment that can treat a water source containing impurities and harmful substances to make it pure and drinkable. A main function of the water purifier is to filter out suspended matter, bacteria, viruses, heavy metals and other harmful substances in the water, while retaining minerals and trace elements in the water that are beneficial to human bodies. There are many types of water purifiers. Based on different filtering methods of the water purifiers, the water purifiers can be mainly divided into reverse osmosis water purifiers, ultrafiltration water purifiers, activated carbon water purifiers, ceramic filtration water purifiers, etc. In general, a water purifier is a type of important equipment that can effectively improve water quality and ensure the safety of drinking water of people.

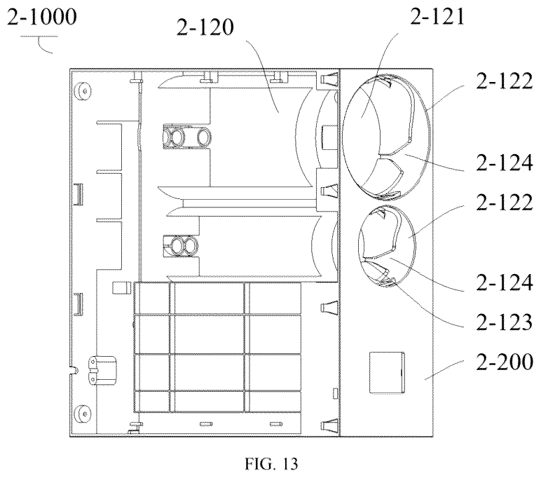

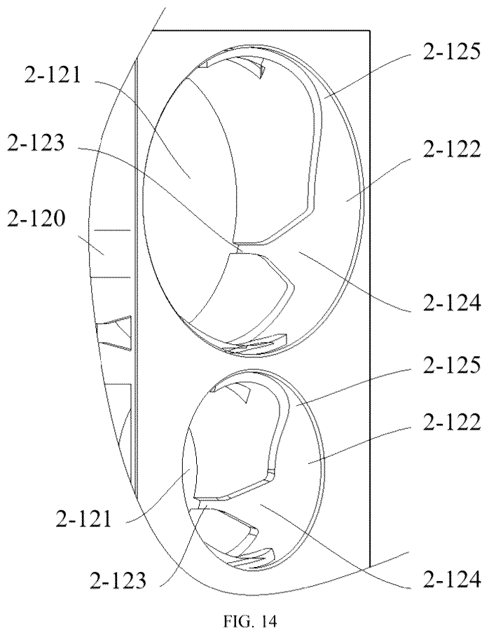

As shown in FIG. 13 and FIG. 14, in some embodiments, the filter cartridge assembly 2-100 includes: a filter cartridge body 2-110 and a filter cartridge mount seat 2-120.

Specifically, the filter cartridge body 2-110 has a filtering function, and the filter cartridge body 2-110 is provided with a water outlet tube 2-116. Water entering the filter cartridge body 2-110, pure water and waste water generated after filtration can all flow out through the corresponding water outlet tube 2-116, and the water outlet tube 2-116 is suitable for connecting to and communicating with a water path plate. The water path plate can be provided with a raw water channel, a waste water channel and a pure water channel, etc. The water outlet tube 2-116 at the filter cartridge body 2-110 can be one or more, and each water outlet tube 2-116 is connected to and communicated with the corresponding water path at the water path plate.

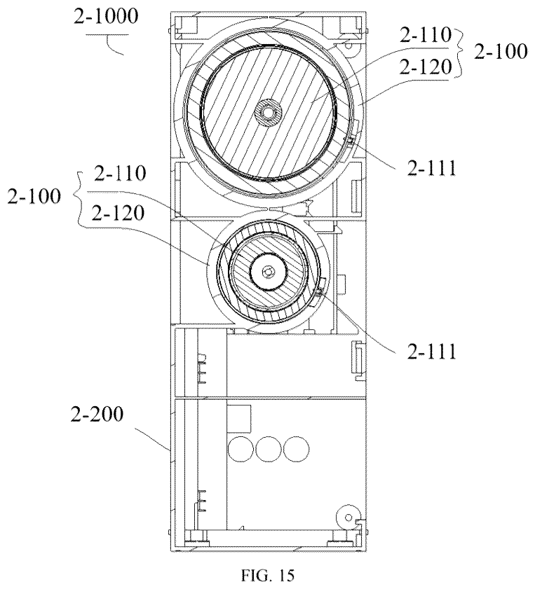

As shown in FIG. 14 and FIG. 15, a mount cavity 2-121 is provided inside the filter cartridge mount seat 2-120, a side of the mount cavity 2-121 is provided with an opening 2-122, and the filter cartridge body 2-110 is able to be mounted at the mount cavity 2-121 through the opening 2-122. Therefore, it facilitates to mount the filter cartridge body 2-110 at the filter cartridge mount seat 2-120. An outer peripheral wall of the filter cartridge body 2-110 is provided with a limit rib 2-111, and an inner wall of the mount cavity 2-121 is provided with a limit slot 2-123. The limit rib 2-111 is slidable along the limit slot 2-123. Matching between the limit rib 2-111 and the limit slot 2-123 is used to limit rotation of the filter cartridge body 2-110 in a circumferential direction of the filter cartridge body.

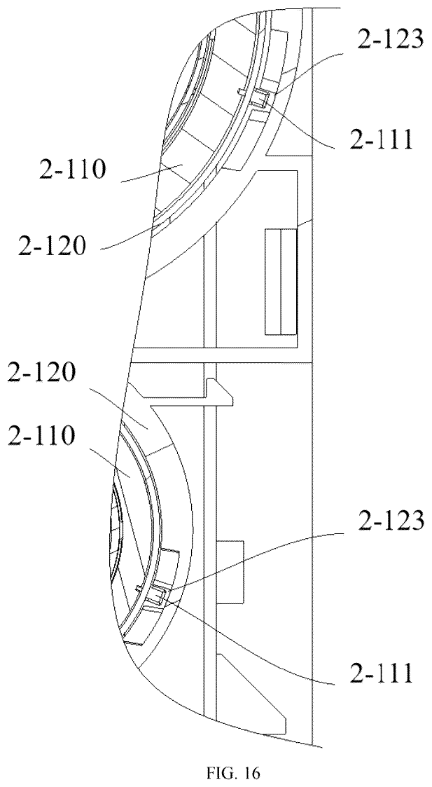

As shown in FIG. 15 and FIG. 16, a limiting function of the limit slot 2-123 can be used to limit a movement range of the limit rib 2-111, and a movement range of the filter cartridge body 2-110 can be further limited. Combined with FIG. 14, in order to facilitate to matching the limit rib 2-111 into the limit slot 2-123, an end of the limit slot 2-123 is provided with a bell mouth 2-124, and the bell mouth 2-124 communicates with the opening 2-122. It should be noted that, on one hand, the bell mouth 2-124 has a guiding function, so that the limit rib 2-111 can be guided into the limit slot 2-123; and on the other hand, the bell mouth 2-124 has advantages of wide mouth inlet and narrow mouth outlet, which facilitates the limit rib 2-111 to be matched into the limit slot 2-123.

In the filter cartridge assembly 2-100 according to the embodiment of the present application, the movement range of the limit rib 2-111 is limited by utilizing the limiting effect of the limit slot 2-123, thereby limiting the movement range of the filter cartridge body 2-110; further, by providing the bell mouth 2-124 at an end of the limit slot 2-123, the guiding effect of the bell mouth 2-124 can be utilized to guide the limit rib 2-111 to match into the limit slot 2-123, and the bell mouth 2-124 has advantages of wide mouth inlet and narrow mouth outlet, so that the limit rib 2-111 can be matched into the limit slot 2-123.

According to some embodiments of the present application, a plurality of limit ribs 2-111 are provided, and the plurality of limit ribs 2-111 are spaced apart along the circumferential direction of the filter cartridge body 2-110 Therefore, the stability of the matching between the filter cartridge body 2-110 and the filter cartridge mount seat 2-120 can be improved, and the filter cartridge body 2-110 can be effectively prevented from rotating relative to the filter cartridge mount seat 2-120. In addition, when one of the plurality of limit ribs 2-111 is damaged, other limit ribs 2-111 can also play a limiting role, thereby improving the stability and safety of the matching between filter cartridge body 2-110 and the filter cartridge mount seat 2-120. Correspondingly, when a plurality of limit ribs 2-111 are provided, the filter cartridge mount seat 2-120 is provided with a plurality of limit slots 2-123, and the plurality of limit slots 2-123 are provided in a one-to-one correspondence with the plurality of limit ribs 2-111.

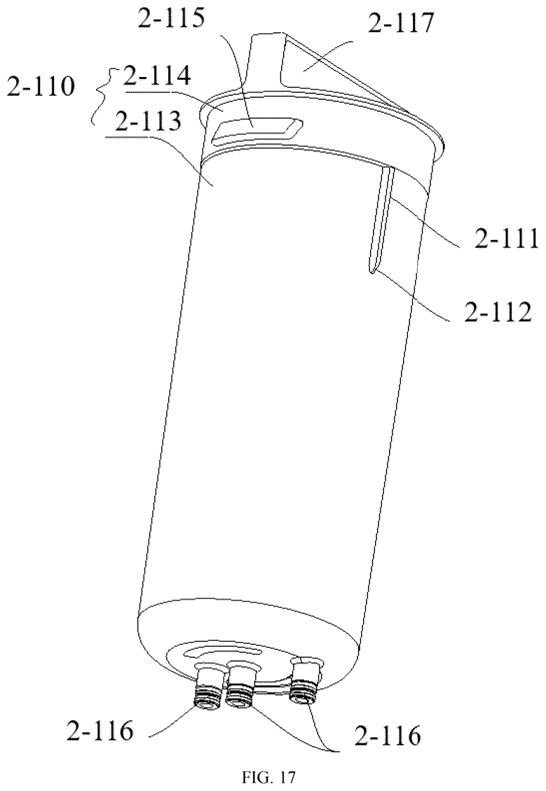

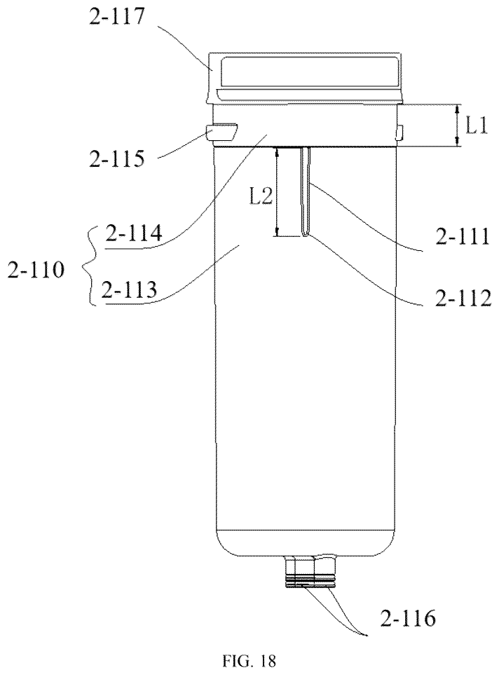

According to some embodiments of the present application, as shown in FIG. 18, a width of the limit rib 2-111 is 2 mm to 5 mm. Therefore, a structural strength of the limit rib 2-111 can be enhanced, matching stability between the limit rib 2-111 and the limit slot 2-123 can be improved, and the filter cartridge body 2-110 can be prevented from rotating relative to the filter cartridge mount seat 2-120. As shown in FIG. 17 and FIG. 18, according to some embodiments of the present application, the limit rib 2-111 is in a shape of straight line. In an embodiment, the limit rib 2-111 extends in a straight line, so that the limit rib 2-111 can be smoothly matched inside the limit slot 2-123, thereby improving matching convenience between the filter cartridge body 2-110 and the filter cartridge mount seat 2-120. In addition, the linear limit rib 2-111 is simple and intuitive in design, with relatively low processing cost, and is easy to be processed and mounted.

According to some embodiments of the present application, as shown in FIG. 18, an end of the limit rib 2-111 is provided with a guide slope 2-112. The guide slope 2-112 has a guiding function, which can guide the filter cartridge body 2-110 into the limit slot 2-123. For example, when mounting the filter cartridge body 2-110 at the filter cartridge mount seat 2-120, the filter cartridge body 2-110 can be first inserted into the opening 2-122 of the mount cavity 2-121, and then the guide slope 2-112 at the limit rib 2-111 is used for sliding the filter cartridge body 2-110 into the bell mouth 2-124. Under guidance of the guide slope 2-112 and the bell mouth 2-124, the limit rib 2-111 slides inside the limit slot 2-123, the limit rib 2-111 slides along the limit slot 2-123, and the filter cartridge body 2-110 moves to a predetermined position. Therefore, under the guidance and lead of the guide slope 2-112 and the bell mouth 2-124, the filter cartridge body 2-110 can be smoothly mounted to the predetermined position. In addition, it should be noted that an inclined slope at the guide slope 2-112 not only facilitates demoulding, but also effectively alleviates stress concentration, prevents fatigue damage to the limit rib 2-111, and effectively extends a service life of the limit rib 2-111.

As shown in FIG. 17 and FIG. 18, according to some embodiments of the present application, the filter cartridge body 2-110 further includes: a body member 2-113 and a cover body 2-114. Specifically, the limit rib 2-111 is provided at an outer peripheral wall of the body member 2-113, the body member 2-113 is provided inside the mount cavity 2-121, and the body member 2-113 is slidable along a length direction of the limit slot 2-123. The cover body 2-114 covers an end of the body member 2-113, a part of the cover body 2-114 is located inside the opening 2-122, and the cover body 2-114 is rotatable relative to the body member 2-113.

In an embodiment, in an axial direction of the body member 2-113 or in a direction in which the body member 2-113 moves along the limit slot 2-123, the body member 2-113 is slidable relative to the filter cartridge mount seat 2-120, and the body member 2-113 is stationary relative to the filter cartridge mount seat 2-120. In a circumferential direction of the body member 2-113 or in a circumferential direction in which the body member 2-113 moves along the limit slot 2-123, the body member 2-113 is stationary relative to the filter cartridge mount seat 2-120, and the cover body 2-114 is rotatable relative to the body member 2-113. On one hand, it facilitates assembling the filter cartridge body 2-110 at the filter cartridge mount seat 2-120; and on the other hand, it also facilitates mounting the water outlet tube 2-116 of the filter cartridge body 2-110 at the water path plate.

In order to facilitate the operator to grip the filter cartridge body 2-110, as shown in FIG. 17 and FIG. 18, a side of the cover body 2-114 away from the body member 2-113 is provided with a handle member 2-117, and the handle member 2-117 is in a shape of a knob, so that the operator can rotate the cover body 2-114 by gripping the handle member 2-117.

As shown in FIG. 18, according to some embodiments of the present application, in a length direction of the limit rib 2-111, a width of the cover body 2-114 is less than a length of the limit rib 2-111. For example, as shown in FIG. 18, the width of the cover body 2-114 is L1, and the length of the limit rib 2-111 is L2, where L2>L1. By providing the length of the limit rib 2-111 to be greater than the width of the cover body 2-114, when the filter cartridge body 2-110 is mount at the filter cartridge mount seat 2-120, the filter cartridge body 2-110 can be first inserted into the opening 2-122 of the mount cavity 2-121. Under a condition of being structural blocked by the cover body 2-114, an assembler can observe a position of the limit rib 2-111, which facilitates adjusting the limit rib 2-111 to a position of the bell mouth 2-124.

In addition, when a position of the filter cartridge body 2-110 inserted into the opening 2-122 is misaligned, since the length of the limit rib 2-111 is greater than the width of the cover body 2-114, the assembler can promptly find that the position of the limit rib 2-111 does not correspond to the position of the bell mouth 2-124, which facilitates the assembler to promptly adjust the position of the limit rib 2-111, and facilitates assembling the filter cartridge body 2-110 inside the filter cartridge mount seat 2-120.

As shown in FIG. 17 and FIG. 18, according to some embodiments of the present application, the cover body 2-114 is provided with a rotation convex strip 2-115, and an inner peripheral wall of the mount cavity 2-121 is provided with a rotation groove 2-125 rotation groove 2-125. The rotation groove 2-125 rotation groove 2-125 extends along a circumferential direction of the body member 2-113, and the limit slot 2-123 extends along a length direction of the body member 2-113. Under matching between the rotation convex strip 2-115 and the rotation groove 2-125 rotation groove 2-125, and matching between the limit slot 2-123 and the limit rib 2-111, and the cover body 2-114 and the body member 2-113 move along a direction of the limit slot 2-123 while the cover body 2-114 rotates relative to the body member 2-113.

In an embodiment, under the matching between the rotation groove 2-125 rotation groove 2-125 and the rotation convex strip 2-115, the cover body 2-114 plays a role in pushing the body member 2-113 to move, so that the body member 2-113 can move along an extension direction of the limit slot 2-123, the filter cartridge body 2-110 can move along the extension direction of the limit slot 2-123 where the mount cavity 2-121 moves along, and then the filter cartridge body 2-110 can have an assembly force in its axial direction, so that when the filter cartridge body 2-110 is inserted into the mount cavity 2-121, the filter cartridge body 2-110 also has an assembly force of being plugged with the water path plate, to plug the filter cartridge body 2-110 with the water path plate. For the convenience of understanding, the matching between the rotation groove 2-125 rotation groove 2-125 and the rotation convex strip 2-115 can be understood as a threaded matching. In order to facilitate the matching between the rotation groove 2-125 rotation groove 2-125 and the rotation convex strip 2-115, as shown in FIG. 14, the opening 2-122 of the rotation groove 2-125 rotation groove 2-125 communicates with the bell mouth 2-124.

The filter cartridge assembly 2-100 according to the embodiments of the present application is described in detail in conjunction with FIG. 13 to FIG. 18. The following description is only an exemplary specification, not a specific limitation of the present application.

As shown in FIG. 13, the filter cartridge assembly 2-100 includes a filter cartridge body 2-110 and a filter cartridge mount seat 2-120. The filter cartridge body 2-110 has a filtering function, and the filter cartridge body 2-110 is provided with a water outlet tube 2-116. Water entering the filter cartridge body 2-110, pure water and waste water generated after filtration can all flow out through the corresponding water outlet tube 2-116, the water outlet tube 2-116 is plugged with the water path plate, and the corresponding water outlet tube 2-116 is suitable for communicating with the corresponding water path on the water path plate.

As shown in FIG. 14 and FIG. 15, a mount cavity 2-121 is provided inside the filter cartridge mount seat 2-120, a side of the mount cavity 2-121 is provided with an opening 2-122, and the filter cartridge body 2-110 is able to be mounted at the mount cavity 2-121 through the opening 2-122. An outer peripheral wall of the filter cartridge body 2-110 is provided with a limit rib 2-111, and an inner wall of the mount cavity 2-121 is provided with a limit slot 2-123. The limit rib 2-111 is slidable along the limit slot 2-123. Matching between the limit rib 2-111 and the limit slot 2-123 is used to limit rotation of the filter cartridge body 2-110 in a circumferential direction of the filter cartridge body.

As shown in FIG. 17 and FIG. 18, the filter cartridge body 2-110 further includes a body member 2-113 and a cover body 2-114. The limit rib 2-111 is provided at an outer peripheral wall of the body member 2-113, the body member 2-113 is provided inside the mount cavity 2-121, and the body member 2-113 is slidable along a length direction of the limit slot 2-123. The cover body 2-114 covers an end of the body member 2-113, a part of the cover body 2-114 is located inside the opening 2-122, and the cover body 2-114 is rotatable relative to the body member 2-113. In an embodiment, in an axial direction of the body member 2-113 or a direction in which the body member 2-113 moves along the limit slot 2-123, the body member 2-113 can slide relative to the filter cartridge mount seat 2-120, and the body member 2-113 is stationary relative to the filter cartridge mount seat 2-120. In a circumferential direction of the body member 2-113 or a circumferential direction in which the body member 2-113 moves along the limit slot 2-123, the body member 2-113 is stationary relative to the filter cartridge mount seat 2-120, and the cover body 2-114 is rotatable relative to the body member 2-113. On one hand, it facilitates assembling the filter cartridge body 2-110 at the filter cartridge mount seat 2-120; and on the other hand, it also facilitates mounting the water outlet tube 2-116 of the filter cartridge body 2-110 at the water path plate.

As shown in FIG. 18, the cover body 2-114 is provided with a rotation convex strip 2-115, and an inner peripheral wall of the mount cavity 2-121 is provided with a rotation groove 2-125 rotation groove 2-125. The rotation groove 2-125 rotation groove 2-125 extends along a circumferential direction of the body member 2-113, and the limit slot 2-123 extends along a length direction of the body member 2-113. Under matching between the rotation convex strip 2-115 and the rotation groove 2-125 rotation groove 2-125, and matching between the limit slot 2-123 and the limit rib 2-111, and the cover body 2-114 and the body member 2-113 move along a direction of the limit slot 2-123 while the cover body 2-114 rotates relative to the body member 2-113. In an embodiment, under matching between the rotation groove 2-125 rotation groove 2-125 and the rotation convex strip 2-115, the cover body 2-114 plays a role in pushing the body member 2-113 to move, so that the body member 2-113 can move along an extension direction of the limit slot 2-123, the filter cartridge body 2-110 can move along the extension direction of the limit slot 2-123 where the mount cavity 2-121 moves along, and then the filter cartridge body 2-110 can have an assembly force in its axial direction, so that when the filter cartridge body 2-110 is inserted into the mount cavity 2-121, the filter cartridge body 2-110 also has an assembly force of being plugged with the water path plate, to plug the filter cartridge body 2-110 with the water path plate.

As shown in FIG. 18, a width of the limit rib 2-111 is 2 mm to 5 mm, and an end of the limit rib 2-111 is provided with a guide slope 2-112. The guide slope 2-112 has a guiding function, which can guide the filter cartridge body 2-110 into the limit slot 2-123. For example, when mounting the filter cartridge body 2-110 at the filter cartridge mount seat 2-120, the filter cartridge body 2-110 can be first inserted into the opening 2-122 of the mount cavity 2-121, and then the guide slope 2-112 at the limit rib 2-111 is used for sliding the filter cartridge body 2-110 into the bell mouth 2-124. Under guidance of the guide slope 2-112 and the bell mouth 2-124, the limit rib 2-111 slides inside the limit slot 2-123, the limit rib 2-111 slides along the limit slot 2-123, and the filter cartridge body 2-110 moves to a predetermined position.

In a length direction of the limit rib 2-111, a width of the cover body 2-114 is less than a length of the limit rib 2-111. For example, as shown in FIG. 18, the width of the cover body 2-114 is L1, and the length of the limit rib 2-111 is L2, where L2>L1. By providing the length of the limit rib 2-111 to be greater than the width of the cover body 2-114, when the filter cartridge body 2-110 is mount at the filter cartridge mount seat 2-120, the filter cartridge body 2-110 can be first inserted into the opening 2-122 of the mount cavity 2-121. Even under a condition of being structural blocked by the cover body 2-114, an assembler can still observe a position of the limit rib 2-111, which facilitates adjusting the limit rib 2-111 to a position of the bell mouth 2-124.

Referring to FIG. 13 and FIG. 15, a water purification device 2-1000 according to the embodiments of the present application includes a machine housing 2-200 and the filter cartridge assembly 2-100 as described above. Specifically, the filter cartridge assembly 2-100 is provided inside the machine housing 2-200, the machine housing 2-200 and the filter cartridge mount seat 2-120 of the filter cartridge assembly 2-100 are integrally formed, and the opening 2-122 of the filter cartridge assembly 2-100 is provided at the machine housing 2-200. It should be noted that the filter cartridge mount seat 2-120 and the machine housing 2-200 are molded simultaneously through a single injection molding process, to construct an integrated part, which can reduce production costs, simplify assembly steps, reduce production costs, and improve production efficiency.

In the water purification device 2-1000 according to the embodiment of the present application, the movement range of the limit rib 2-111 is limited by utilizing the limiting effect of the limit slot 2-123, thereby limiting the movement range of the filter cartridge body 2-110; further, by providing the bell mouth 2-124 at an end of the limit slot 2-123, the guiding effect of the bell mouth 2-124 can be utilized to guide the limit rib 2-111 to match into the limit slot 2-123, and the bell mouth 2-124 has advantages of wide mouth inlet and narrow mouth outlet, so that the limit rib 2-111 can be matched into the limit slot 2-123.

According to some embodiments of the present application, the water purification device 2-1000 further includes a booster pump, a water path plate, a pump body mount seat and a plate body mount seat. The pump body mount seat is used to bear the booster pump, and the plate body mount seat is used to bear the water path plate. In order to simplify assembly procedure of the water purification device 2-1000, the machine housing 2-200, the filter cartridge mount seat 2-120, the pump body mount seat and the plate body mount seat can be made by a single injection molding process, that is, the machine housing 2-200, the filter cartridge mount seat 2-120, the pump body mount seat and the plate body mount seat are integrally formed parts, which can reduce production costs, simplify assembly steps, reduce production costs, and improve production efficiency.

Further, the opening 2-122 of the pump body mount seat faces the same direction as the opening 2-122 of the plate body mount seat, so that when the booster pump and the water path plate are mounted, they can be mounted in the same assembly direction, there is no need to flip the machine housing 2-200, thereby simplifying assembly procedure of the water purification device 2-1000 and shortening the assembly cycle.

It should be noted that, the above embodiments are only used to illustrate the present application, but not to limit the present application. Although the present application has been described in detail with reference to the embodiments, those skilled in the art should understand that various combinations, modifications, or equivalent replacements of the solutions of the present application do not depart from the scope of the solutions of the present application, and should be all covered by the scope of the claims of the present application.

1.-30. (canceled)

31. A filter cartridge assembly comprising:
a filter cartridge base body, provided with a mount cavity and a mount port communicating with the mount cavity, a guide-out slot communicating with the mount port being provided at an inner wall of the mount port, and the guide-out slot extending obliquely along a circumference direction of the mount port;
a filter cartridge body inside the mount cavity and including a water path plate at a first end of the filter cartridge body and a rotatable connector at a second end of the filter cartridge body; and
an end cover provided at the mount port and rotatably connected to the filter cartridge body through the rotatable connector, the end cover including a snap protrusion at an outer peripheral wall of the end cover and corresponding to the guide-out slot, and the snap protrusion being slidable along the guide-out slot to bring a part of the filter cartridge body away from the mount cavity along an axial direction.

32. The filter cartridge assembly of claim 31, wherein the snap protrusion includes an inclined end surface and an abut protrusion member at an end of a side of the inclined end surface close to the guide-out slot, and the abut protrusion member abuts against and matches with a slot wall of the guide-out slot.

33. The filter cartridge assembly of claim 32, wherein the guide-out slot includes a guide-out wall along the circumference direction of the mount port in a streamlined manner, the guide-out wall includes a first guide-out segment and a second guide-out segment, and a radian of the first guide-out segment is greater than a radian of the second guide-out segment.

34. The filter cartridge assembly of claim 33, wherein:
a central angle corresponding to an arc length of the first guide-out segment extending along the circumference direction of the mount port is greater than or equal to 10°; and/or
an inclination angle of the inclined end surface is greater than an inclination angle of the guide-out wall.

35. The filter cartridge assembly of claim 31, wherein a side of the end cover away from the filter cartridge body is raised to form a grip member.

36. The filter cartridge assembly of claim 35, wherein:
an outer peripheral edge of an end of the grip member away from the filter cartridge body protrudes to form an undercut; and/or
a raise distance of the grip member along an axial direction of the end cover is greater than or equal to 12 mm.

37. The filter cartridge assembly of claim 31, wherein the end cover includes a flange at an outer peripheral edge of the end cover toward the filter cartridge body, the flange covers the second end of the filter cartridge body, and the snap protrusion is provided at an outer wall surface of the flange.

38. A water purification device comprising the filter cartridge assembly of claim 31.

39. A filter cartridge assembly comprising:
a filter cartridge base body provided with a mount cavity and a mount port communicated with the mount cavity, and an inner wall of the mount port is provided with a guide slot;
a filter cartridge body inside the mount cavity and including a water path plate at a first end of the filter cartridge body and a rotatable connector at a second end of the filter cartridge body; and
an end cover provided at the mount port and rotatably connected to the filter cartridge body through the rotatable connector, the end cover including a snap protrusion at an outer peripheral wall of the end cover and corresponding to the guide slot, and the snap protrusion being slidable along the guide slot to lock or unlock the filter cartridge body at a position of the mount cavity;
wherein an inclination angle of a notch end of the guide slot is different from an inclination angle of a guide-in end of the snap protrusion.

40. The filter cartridge assembly of claim 39, wherein:
the guide slot includes a first guide surface provided at an entrance end of the guide slot, and the first guide surface is provided obliquely along a circumference direction of the mount port;
the snap protrusion includes a second guide surface provided at the guide-in end, the second guide surface is provided obliquely along a circumference direction of the end cover; and
an angle between the first guide surface and an axial direction is different from an angle between the second guide surface and a cross section perpendicular to an axial direction of the end cover.

41. The filter cartridge assembly of claim 40, wherein:
the guide slot further includes a first abut surface connected to an end of the first guide surface away from the notch, the snap protrusion further includes a second abut surface connected to a side of the second guide surface away from the guide-in end, the second abut surface extends along the circumference direction of the end cover, and the first abut surface and the second abut surface abut against each other;
the angle between the first guide surface and the axial direction is greater than or equal to 30°;
the angle between the second guide surface and the cross section perpendicular to the axial direction of the end cover is greater than or equal to 30°; and/or
a slot bottom wall of the guide slot is provided obliquely, and an angle between the slot bottom wall and a cross section perpendicular to an axial direction of the filter cartridge base body is greater than or equal to the angle between the second guide surface and the cross section perpendicular to the axial direction of the end cover.

42. A water purification device comprising:
an outer housing; and
the filter cartridge assembly of claim 39.

43. A filter cartridge assembly comprising:
a filter cartridge body including a limit rib at an outer peripheral wall of the filter cartridge body; and
a filter cartridge mount seat, a mount cavity being provided inside the filter cartridge mount seat, a side of the mount cavity being provided with an opening;
wherein:
the filter cartridge body is configured to be mounted at the mount cavity through the opening;
an inner wall of the mount cavity is provided with a limit slot, an end of the limit slot being provided with a bell mouth communicating with the opening; and
the limit rib is slidable along the limit slot, and the limit rib and the limit slot are configured to cooperate with each other to limit rotation of the filter cartridge body in a circumferential direction of the filter cartridge body.

44. The filter cartridge assembly of claim 43, wherein the limit rib is one of a plurality of limit ribs at the outer peripheral wall of the filter cartridge body, and the plurality of limit ribs are spaced apart from each other along the circumferential direction of the filter cartridge body.

45. The filter cartridge assembly of claim 43, wherein:
a width of the limit rib is 2 mm to 5 mm;
the limit rib is in a shape of straight line; and/or
an end of the limit rib is provided with a guide slope.

46. The filter cartridge assembly of claim 43, wherein the filter cartridge body includes:
a body member inside the mount cavity and slidable along a length direction of the limit slot, the limit rib being provided at an outer peripheral wall of the body member; and
a cover body covering an end of the body member, a part of the cover body being located inside the opening, and the cover body being rotatable relative to the body member.

47. The filter cartridge assembly of claim 46, wherein in a length direction of the limit rib, a width of the cover body is less than a length of the limit rib.

48. The filter cartridge assembly of claim 46, wherein:
the cover body includes a rotation convex strip;
an inner peripheral wall of the mount cavity is provided with a rotation groove extending along a circumferential direction of the body member;
the limit slot extends along a length direction of the body member;
the rotation convex strip, the rotation groove, the limit slot, and the limit rib are configured to cooperate with each other to enable the cover body and the body member to move along a direction of the limit slot while the cover body rotates relative to the body member.

49. The filter cartridge assembly of claim 48, wherein an opening of the rotation groove communicates with the bell mouth.

50. A water purification device comprising:
a machine housing; and
the filter cartridge assembly of claim 43 inside the machine housing;
wherein:
the machine housing and the filter cartridge mount seat of the filter cartridge assembly are integrally formed; and
an opening of the filter cartridge assembly is provided at the machine housing.
